(19) United States
(12) Patent Application Publication
(10) Pub. No.: US 2017/0031551 A1
(43) Pub. Date: Feb. 2, 2017

(54) PEER DRIVEN EDITING

(71) Applicant: LinkedIn Corporation, Mountain View, CA (US)

(72) Inventors: Lokesh P. Bajaj, Fremont, CA (US); Alexis Blevins Baird, San Francisco, CA (US); Sachit Kamat, San Carlos, CA (US); Kevin Jonathan Simon, San Carlos, CA (US)

(21) Appl. No.: 14/961,479

(22) Filed: Dec. 7, 2015

Related U.S. Application Data
(60) Provisional application No. 62/199,191, filed on Jul. 30, 2015.

(51) Int. Cl. G06F 3/0484; H04L 29/08

(52) U.S. Cl. CPC G06F 3/0484; H04L 67/306; H04L 67/22; H04L 67/02

(57) ABSTRACT

A system, a machine-readable storage medium storing instructions, and a computer-implemented method are directed to a Peer Driven Editing Engine (hereinafter “PDE Engine”) that updates a profile of a target member account in a professional social network service (hereinafter “social network”) based on information provided from other member accounts. The PDE Engine identifies a particular type of profile attribute of a member account in a social network. The PDE Engine determines a target member account qualifies for an update with the particular type of profile attribute. The PDE Engine generates a prompt based on the particular type of profile attribute. The PDE Engine generates profile update content based on the target member account's response to the prompt. The PDE Engine includes the particular type of profile attribute in the target member account according to the profile update content.

### CROSS-REFERENCE TO RELATED APPLICATIONS

This application claims the benefit of priority to U.S. Provisional Patent Application entitled “Peer Driven Editing,” Ser. No. 62/199,191, filed Jul. 30, 2015, which is hereby incorporated herein by reference in its entirety.

### TECHNICAL FIELD

The present disclosure generally relates to data processing systems. More specifically, the present disclosure relates to methods, systems and computer program products for updating profiles in a social network.

### BACKGROUND

A social networking service is a computer- or web-based application that enables users to establish links or connections with persons for the purpose of sharing information with one another. Some social networking services aim to enable friends and family to communicate with one another, while others are specifically directed to business users with a goal of enabling the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

With many social networking services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social networking services in use today, the personal information that is commonly requested and displayed includes a member's age, gender, interests, contact information, home town, address, the name of the member's spouse and/or family members, and so forth. With certain social networking services, such as some business networking services, a member's personal information may include information commonly included in a professional resume or curriculum vitae, such as information about a person's education, employment history, skills, professional organizations, and so on. With some social networking services, a member's profile may be viewable to the public by default, or alternatively, the member may specify that only some portion of the profile is to be public by default. Accordingly, many social networking services serve as a sort of directory of people to be searched and browsed.

### DESCRIPTION OF THE DRAWINGS

Some embodiments are illustrated by way of example and not limitation in the figures of the accompanying drawings in which:

FIG. 1 is a block diagram illustrating a client-server system, in accordance with an example embodiment;

FIG. 2 is a block diagram showing functional components of a professional social network within a networked system, in accordance with an example embodiment;

FIG. 3 is a block diagram showing example components of a Peer Driven Editing Engine, according to some embodiments;

FIG. 4 is a block diagram showing an identification of a target member account, according to some embodiments;

FIG. 5 is a block diagram showing a prompt for updating a target member account, according to some embodiments;

FIG. 6 is a flowchart illustrating a method of updating a target member account, according to embodiments described herein;

FIG. 7 is a block diagram of an example computer system on which methodologies described herein may be executed, in accordance with an example embodiment.

### DETAILED DESCRIPTION

The present disclosure describes methods and systems for leveraging insights about a less-engaged member account received from more highly-engaged member accounts to generate a prompt(s) for the less-engaged member account. Based on the response to the prompt, profile update content for the less-engaged member account is generated and less-engaged member account's profile is updated according to the profile update content. In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

A system, a machine-readable storage medium storing instructions, and a computer-implemented method are directed to a Peer Driven Editing Engine (hereinafter “PDE Engine”) that updates a profile of a target member account in a professional social network service (hereinafter “professional social network” and “social network”) based on information provided from another member account(s).

The PDE Engine identifies a particular type of profile attribute of a member account in a social network. The PDE Engine determines a target member account qualifies for an update with the particular type of profile attribute. The PDE Engine generates a prompt based on the particular type of profile attribute. The PDE Engine generates profile update content based on the target member account's response to the prompt. The PDE Engine includes the particular type of profile attribute in the target member account according to the profile update content.

In some embodiments, the PDE Engine identifies a member account that is very active in the social network and/or has a profile that meets a profile completion threshold. The PDE Engine utilizes the member account to help identify a target member account in order to generate prompts for the target member account. For example, the PDE Engine detects an educational institution attribute (“State University”) in the member account's profile. The PDE Engine generates an inquiry for the member account requesting that the member account identify one or more classmates from the education institution. When the member account indicates an identity of a classmate, that classmate's corresponding member account (i.e. target member account) in the social network is located.

In another example, the PDE Engine detects a previous employer attribute (“Corp. A”) in the member account's profile. The PDE Engine generates an inquiry for the member account requesting that the member account identify one or more former colleagues at the previous employer. When the member account indicates an identity of a former colleague, that former colleague's corresponding member account (i.e. target member account) in the social network is located.

The PDE Engine generates a prompt with content about the educational institution (or content about the previous employer). For example, the prompt may display content such as “Did you attend State University?” or “Did you work at Corp. A?” When the target member account responds affirmatively to the prompt, the PDE Engine generates profile update content based on the target member account's response. The PDE Engine updates the target member account's profile in the social network according to the profile update content. Continuing with the example, if the PDE Engine receives an affirmative response from the target member account, the PDE Engine updates the target member account's to include an attribute representative of attendance at State University or to include an attribute representative of employment at Corp. A.

It is understood that the embodiments described herein are not limited to profile attributes related to educational institutions and employers. As an example, an attribute(s) can be indicative at least one of a skill, a group affiliation, a geographic location, a type of education degree or certification, a job title, and a personal or professional interest.

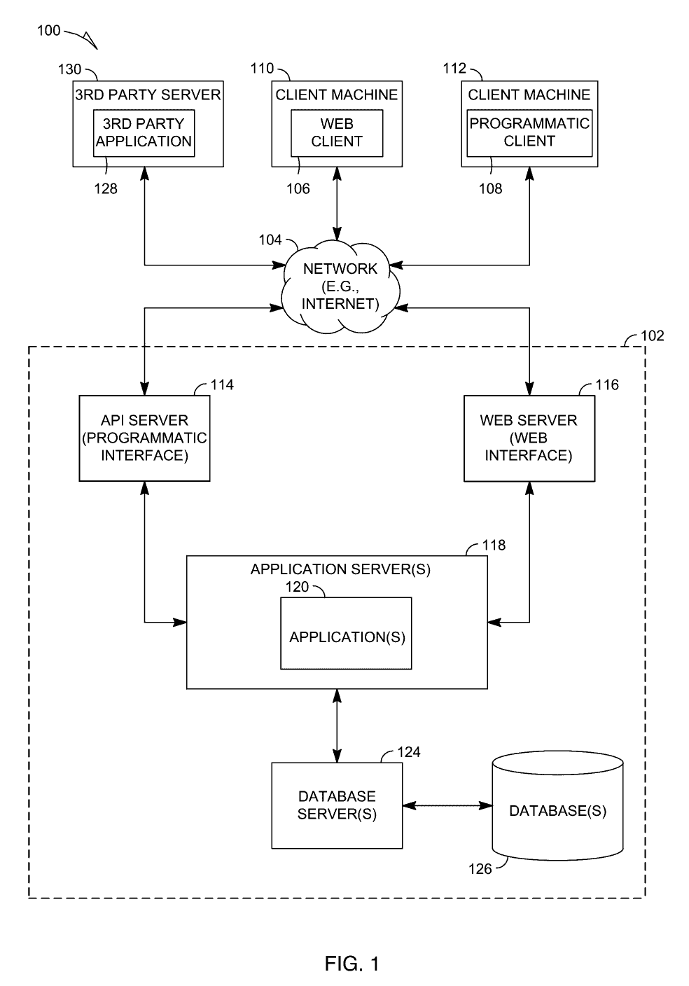

Turning now to FIG. 1, FIG. 1 is a block diagram illustrating a client-server system, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102. In some embodiments, the networked system 102 may comprise functional components of a professional social network.

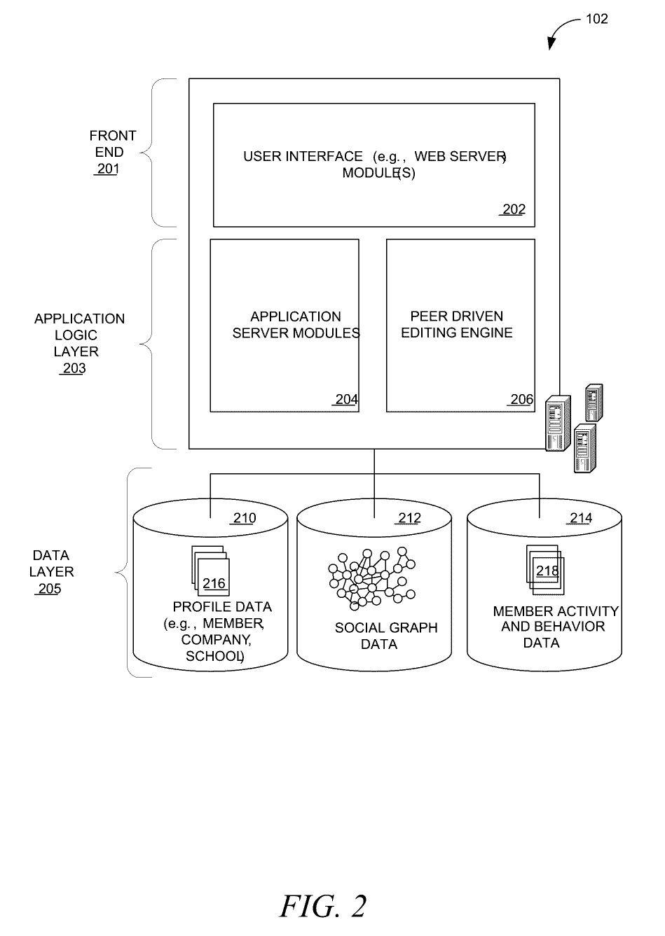

FIG. 2 is a block diagram showing functional components of a professional social network within the networked system 102, in accordance with an example embodiment.

As shown in FIG. 2, the professional social network may be based on a three-tiered architecture, consisting of a front-end layer 201, an application logic layer 203, and a data layer 205. In some embodiments, the modules, systems, and/or engines shown in FIG. 2 represent a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 2. However, one skilled in the art will readily recognize that various additional functional modules and engines may be used with a professional social network, such as that illustrated in FIG. 2, to facilitate additional functionality that is not specifically described herein. Furthermore, the various functional modules and engines depicted in FIG. 2 may reside on a single server computer, or may be distributed across several server computers in various arrangements. Moreover, although a professional social network is depicted in FIG. 2 as a three-tiered architecture, the inventive subject matter is by no means limited to such architecture. It is contemplated that other types of architecture are within the scope of the present disclosure.

As shown in FIG. 2, in some embodiments, the front-end layer 201 comprises a user interface module (e.g., a web server) 202, which receives requests and inputs from various client-computing devices, and communicates appropriate responses to the requesting client devices. For example, the user interface module(s) 202 may receive requests in the form of Hypertext Transport Protocol (HTTP) requests, or other web-based, application programming interface (API) requests.

In some embodiments, the application logic layer 203 includes various application server modules 204, which, in conjunction with the user interface module(s) 202, generates various user interfaces (e.g., web pages) with data retrieved from various data sources in the data layer 205. In some embodiments, individual application server modules 204 are used to implement the functionality associated with various services and features of the professional social network. For instance, the ability of an organization to establish a presence in a social graph of the social network service, including the ability to establish a customized web page on behalf of an organization, and to publish messages or status updates on behalf of an organization, may be services implemented in independent application server modules 204. Similarly, a variety of other applications or services that are made available to members of the social network service may be embodied in their own application server modules 204.

As shown in FIG. 2, the data layer 205 may include several databases, such as a database 210 for storing profile data 216, including both member profile attribute data as well as profile attribute data for various organizations. Consistent with some embodiments, when a person initially registers to become a member of the professional social network, the person will be prompted to provide some profile attribute data such as, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information may be stored, for example, in the database 210. Similarly, when a representative of an organization initially registers the organization with the professional social network the representative may be prompted to provide certain information about the organization. This information may be stored, for example, in the database 210, or another database (not shown). With some embodiments, the profile data 216 may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or a seniority level within a particular company. With some embodiments, importing or otherwise accessing data from one or more externally hosted data sources may enhance profile data 216 for both members and organizations. For instance, with companies in particular, financial data may be imported from one or more external data sources, and made part of a company's profile.

The profile data 216 may also include information regarding settings for members of the professional social network. These settings may comprise various categories, including, but not limited to, privacy and communications. Each category may have its own set of settings that a member may control.

Once registered, a member may invite other members, or be invited by other members, to connect via the professional social network. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, may be stored and maintained as social graph data within a social graph database 212.

The professional social network may provide a broad range of other applications and services that allow members the opportunity to share and receive information, often customized to the interests of the member. For example, with some embodiments, the professional social network may include a photo sharing application that allows members to upload and share photos with other members. With some embodiments, members may be able to self-organize into groups, or interest groups, organized around a subject matter or topic of interest. With some embodiments, the professional social network may host various job listings providing details of job openings with various organizations.

As members interact with the various applications, services and content made available via the professional social network, the members' behaviour (e.g., content viewed, links or member-interest buttons selected, etc.) may be monitored and information 218 concerning the member's activities, profile completeness, level of engagement, level of usage and behaviour may be stored, for example, as indicated in FIG. 2, by the database 214. This information 218 may be used to classify the member as being in various categories and may be further considered as an attribute of the member. For example, if the member performs frequent searches of job listings, thereby exhibiting behaviour indicating that the member is a likely job seeker, this information 218 can be used to classify the member as being a job seeker. This classification can then be used as a member profile attribute for purposes of enabling others to target the member for receiving messages, status updates and/or a list of ranked premium and free job postings.

In some embodiments, the professional social network provides an application programming interface (API) module via which third-party applications can access various services and data provided by the professional social network. For example, using an API, a third-party application may provide a user interface and logic that enables an authorized representative of an organization to publish messages from a third-party application to a content hosting platform of the professional social network that facilitates presentation of activity or content streams maintained and presented by the professional social network. Such third-party applications may be browser-based applications, or may be operating system-specific. In particular, some third-party applications may reside and execute on one or more mobile devices (e.g., a smartphone, or tablet computing devices) having a mobile operating system.

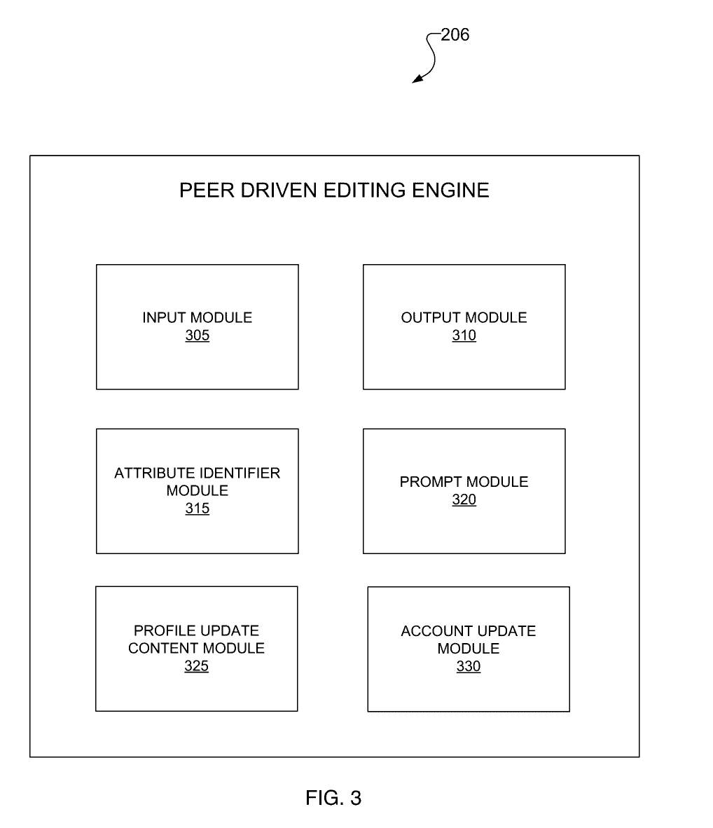

The data in the data layer 205 may be accessed, used, and adjusted by the S.M.A. Engine 206 as will be described in more detail below in conjunction with FIGS. 3-6. Although the S.M.A. Engine 206 is referred to herein as being used in the context of a professional social network, it is contemplated that it may also be employed in the context of any website or online services, including, but not limited to, content sharing sites (e.g., photo- or video-sharing sites) and any other online services that allow users to have a profile and present themselves or content to other users. Additionally, although features of the present disclosure are referred to herein as being used or presented in the context of a web page, it is contemplated that any user interface view (e.g., a user interface on a mobile device or on desktop software) is within the scope of the present disclosure.

FIG. 3 is a block diagram showing example components of a Peer Driven Editing Engine 206, according to some embodiments.

The input module 305 is a hardware-implemented module that controls, manages and stores information related to any inputs from one or more components of system 102 as illustrated in FIG. 1 and FIG. 2. In various embodiments, the inputs include one or more responses to inquiries (i.e. prompts).

The output module 310 is a hardware-implemented module that controls, manages and stores information related to which sends any outputs to one or more components of system 100 of FIG. 1 (e.g., one or more client devices 110, 112, third party server 130, etc.). In some embodiments, the output is one or more prompts and an update profile of a target member account(s).

The attribute identifier module 315 is a hardware implemented module which manages, controls, stores, and accesses information related to identifying a particular type of attribute of a member account. The member account is selected by the attribute identifier module 315 based at least on one of a profile completeness threshold and a usage engagement threshold of the member account.

The prompt module 320 is a hardware-implemented module which manages, controls, stores, and accesses information related to generating a prompt(s) (i.e. inquiries) requesting responses from a respective member account. The prompt module 320 generates prompt content based on one or more attributes of a profile of a respective member account(s) and an input response received from a respective member account(s). In some embodiments, the prompt module 320 determines a prompt module 320 identifies a target member account based on response to a prompt. The prompt module 320 further validates the target member account with respect to at least one of: the profile completeness threshold, the usage engagement threshold and whether a certain degree of connection exists between the target member account and a respective member account.

The profile update content module 325 is a hardware-implemented module which manages, controls, stores, and accesses information related to updating a profile of a target member account. The profile update content module 325 generates profile update content based on a profile attribute(s) of a respective member account(s) as well as a response to a prompt(s).

The account update module 330 is a hardware-implemented module which manages, controls, stores, and accesses information related to updating a target member account. The account update module 330 updates a target member account based at least on the profile update content.

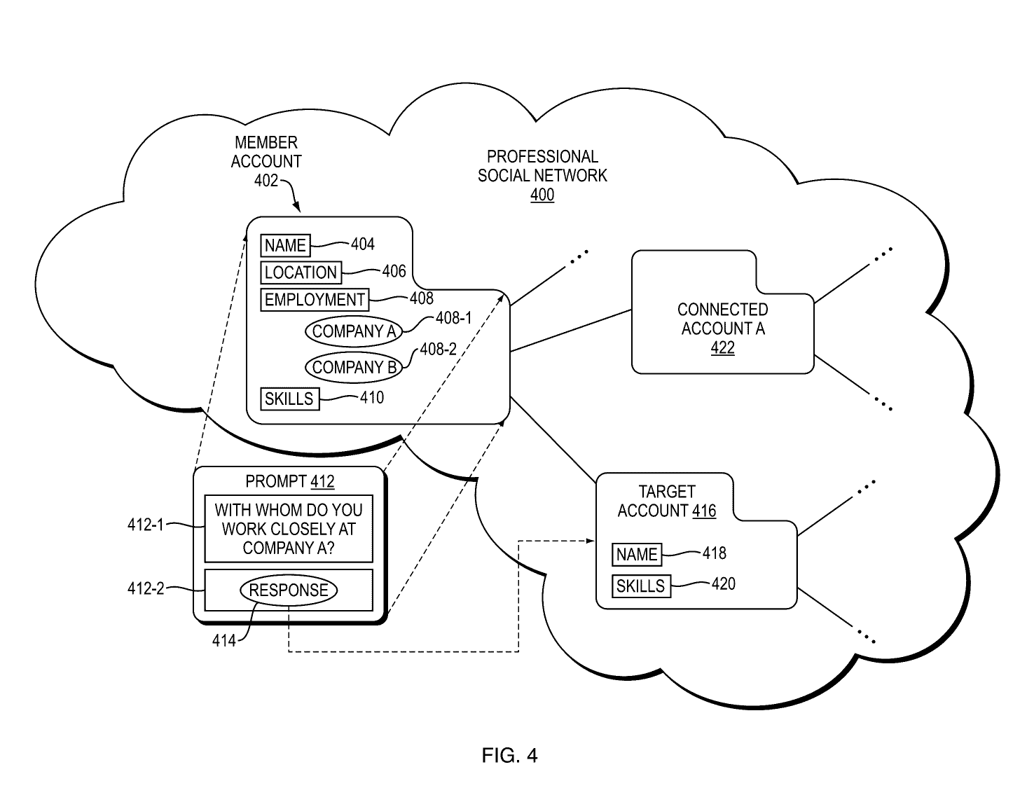

FIG. 4 is a block diagram showing an identification of a target member account 416, according to some embodiments.

A member account 402 in a professional social network 400 has a plurality of connections with other member accounts 416, 422 . . . . The member account 402 has profile that includes profile attributes such as a name 404, location, 406, employment history 408, such as a description of current and former employers 408-1, 408-2 and one or more skills 410.

The PDE Engine 206 generates a prompt 412 with prompt content 412-1 based on a current employer 408-1 of the member account 402. The prompt 412 includes a text input field 412-2 for receipt of an input response 414. The input response 414 corresponds with a target member account 416. The target member account 416 includes profile attributes such as a name 418 and one or more skills 420.

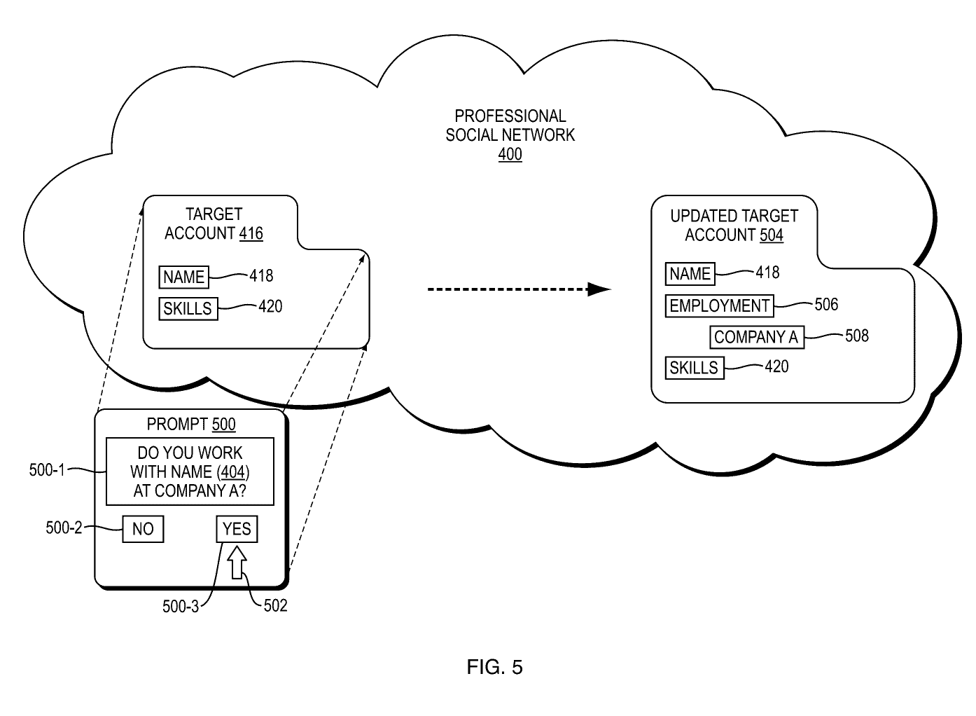

FIG. 5 is a block diagram showing a prompt 500 for updating a target member account 416, according to some embodiments.

The PDE Engine 206 generates a prompt 500 with prompt content 500-1 based on a current employer 408-1 and the name attribute 404 of the member account 402. The prompt 500 includes input buttons 500-2, 500-3. Based on a selection 502 of an input button 500-3, the PDE Engine 206 generates profile update content 506, 508 based on the current employer attribute 408-1 of the member account 502. The PDE Engine 206 applies the profile update content 506, 508 to the target member account 416 to create an updated target member account 504.

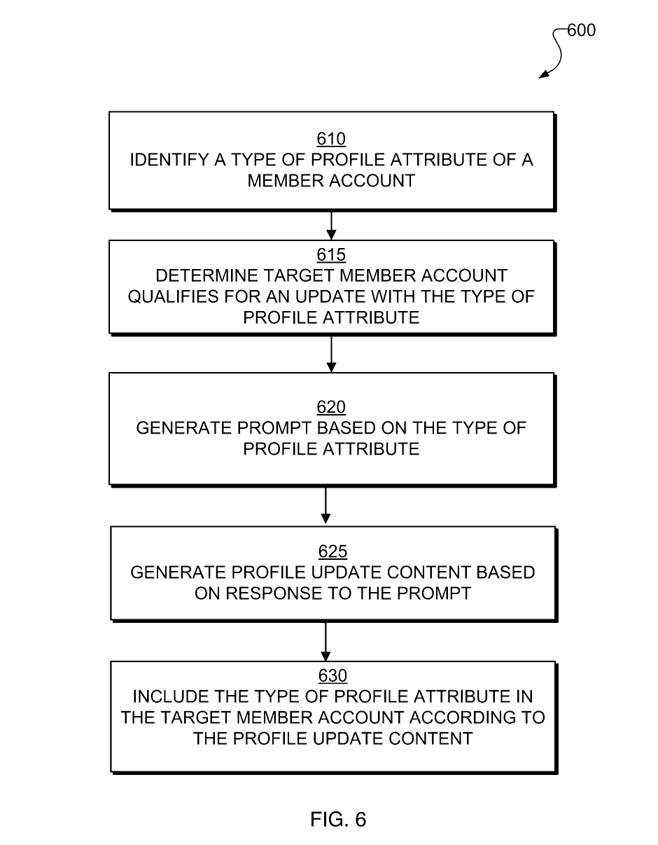

FIG. 6 is a flowchart illustrating a method 600 of updating a target member account, according to embodiments described herein.

At operation 610, the PDE Engine 206 identifies a type of profile attribute of a member account. In one embodiment, the PDE Engine 206 determines a profile of the member account 402 satisfies a profile completeness threshold based on the profile attributes 404, 406, 408, 408-1, 408-2, 410 . . . . In another embodiment, the PDE Engine 206 determines the member account 402 meets an engagement usage threshold which is indicative of the member account 402 being a highly active account in the professional social network. Based on meeting either the profile completeness threshold or the engagement usage threshold, the PDE Engine 206 identifies the current employer 408-1 (“Company A”) listed in the profile of the member account 402. It is understood that the PDR Engine 206 identifies any type of attribute(s) responsive to determining satisfaction of the profile completeness threshold or the engagement usage threshold.

At operation 615, the PDE Engine 206 determines a target member account 416 qualifies for an update with the type of profile attribute. The PDE Engine 206 generates an inquiry, such as a prompt 412 presented to the member account 402, with content 412-1 based on the current employer 408-1 of the member account 402. The PDE Engine 206 receives an input response 414 responsive to the prompt 412. The PDE Engine 206 determines the input response 414 matches a name attribute 418 of a target member account 416.

In one embodiment, the PDE Engine 206 validates the target member account 416 by determining a required threshold degree of connection exists between the member account 402 and the target member account 416. In another embodiment, the PDE Engine 206 validates the target member account 416 by determining the target member account 416 fails to meet the profile completeness threshold. In another embodiment, the PDE Engine 206 validates the target member account 416 by determining the target member account 416 fails to meet the engagement usage threshold. By validating the target member account 416, the PDE Engine 206 determines the target member account 416 should be updated, since the target member account 416 is relatively incomplete or is not often accessed.

At operation 620, the PDE Engine 206 generates a prompt 500 based on the type of the profile attribute. In one embodiment, the prompt 500 is presented to the target member account 416 with content 500-1 based on the name attribute 404 and the current employer attribute 408-1 of the member account 402. The PDE Engine 206 receives a selection 502 of a “YES” input button 500-3, indicating that the target member account 416 and the member account 402 should both have the current employer attribute 408-1.

At operation 625, the PDE Engine 206 generates profile update content 506, 508 based on a response 500-3 to the prompt 500. The profile update content 506, 508 is also based on the current employer attribute 408-1 of the member account 402.

At operation 630, the PDE Engine 206 includes the type of profile attribute in the target member account 416 according to the profile update content 506, 508. The PDE Engine 206 updates the target member account 416 to create an updated target member account 504. The updated target member account 504 includes an employment section 506 with a current employer attribute 508.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

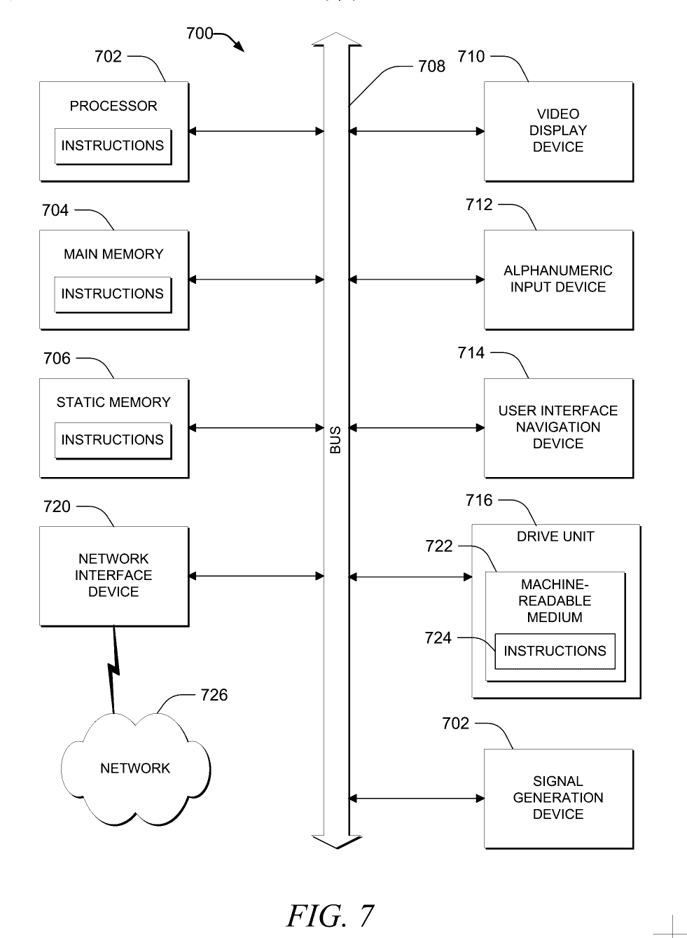

FIG. 7 is a block diagram of a machine in the example form of a computer system 700 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 700 includes a processor 702 (e.g., a central processing unit (CPU), a graphics processing unit (GPU) or both), a main memory 704, and a static memory 706, which communicate with each other via a bus 708. Computer system 700 may further include a video display device 710 (e.g., a liquid crystal display (LCD) or a cathode ray tube (CRT)). Computer system 700 also includes an alphanumeric input device 712 (e.g., a keyboard), a user interface (UI) navigation device 714 (e.g., a mouse or touch sensitive display), a disk drive unit 716, a signal generation device 718 (e.g., a speaker) and a network interface device 720.

Disk drive unit 716 includes a machine-readable medium 722 on which is stored one or more sets of instructions and data structures (e.g., software) 724 embodying or utilized by any one or more of the methodologies or functions described herein. Instructions 724 may also reside, completely or at least partially, within main memory 704, within static memory 706, and/or within processor 702 during execution thereof by computer system 700, main memory 704 and processor 702 also constituting machine-readable media.

While machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 724 may further be transmitted or received over a communications network 726 using a transmission medium. Instructions 724 may be transmitted using network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
identifying a particular type of profile attribute of a member account in a social network;
determining a target member account qualifies for an update with the particular type of profile attribute;
generating a prompt based on the particular type of profile attribute;
generating profile update content based on the target member account's response to the prompt; and
including the particular type of profile attribute in the target member account according to the profile update content.

2. The computer-implemented method of claim 1, wherein determining a target member account qualifies for an update with the particular type of profile attribute comprises:
generating an inquiry based on the particular type of profile attribute for the member account; and
responsive to the inquiry, receiving an identification of the target member account.

3. The computer-implemented method of claim 2, wherein identifying a particular type of profile attribute of a member account in a social network comprises:
determining a profile of the member account in the social network meets a profile completeness threshold; and
identifying the particular type of profile attribute from the profile of the member account.

4. The computer-implemented method of claim 3, wherein receiving an identification of the target member account comprises:
validating the target member based at least on (a) at least a degree of connection in the social network exists between member account and the target member account and (b) a profile of the target member account in the social network fails to meet the profile completeness threshold.

5. The computer-implemented method of claim 2, wherein identifying a particular type of profile attribute of a member account in a social network comprises:
determining the member account in the social network meets an engagement usage threshold; and
identifying the particular type of profile attribute from the profile of the member account.

6. The computer-implemented method of claim 5, wherein receiving an identification of the target member account comprises:
validating the target member based at least on (a) at least a degree of connection in the social network exists between member account and the target member account and (b) the target member account in the social network fails to meet the engagement usage threshold.

7. The computer-implemented method of claim 1, wherein identifying a particular type of profile attribute of a member account in a social network comprises one of:
identifying an identification of an educational institution; and
identifying an identification of an employer.

8. A non-transitory computer-readable medium storing executable instructions thereon,
which, when executed by a processor, cause the processor to perform operations including: identifying a particular type of profile attribute of a member account in a social network;
determining a target member account qualifies for an update with the particular type of profile attribute;
generating a prompt based on the particular type of profile attribute;
generating profile update content based on the target member account's response to the prompt; and
including the particular type of profile attribute in the target member account according to the profile update content.

9. The non-transitory computer-readable medium of claim 8, wherein determining a target member account qualifies for an update with the particular type of profile attribute comprises:
generating an inquiry based on the particular type of profile attribute for the member account; and
responsive to the inquiry, receiving an identification of the target member account.

10. The non-transitory computer-readable medium of claim 9, wherein identifying a particular type of profile attribute of a member account in a social network comprises:
determining a profile of the member account in the social network meets a profile completeness threshold; and
identifying the particular type of profile attribute from the profile of the member account.

11. The non-transitory computer-readable medium of claim 10, wherein receiving an identification of the target member account comprises:
validating the target member based at least on (a) at least a degree of connection in the social network exists between member account and the target member account and (b) a profile of the target member account in the social network fails to meet the profile completeness threshold.

12. The non-transitory computer-readable medium of claim 9, wherein identifying a particular type of profile attribute of a member account in a social network comprises:
determining the member account in the social network meets an engagement usage threshold; and
identifying the particular type of profile attribute from the profile of the member account.

13. The non-transitory computer-readable medium of claim 12, wherein receiving an identification of the target member account comprises:
validating the target member based at least on (a) at least a degree of connection in the social network exists between member account and the target member account and (b) the target member account in the social network fails to meet the engagement usage threshold.

14. The non-transitory computer-readable medium of claim 1, wherein identifying a particular type of profile attribute of a member account in a social network comprises one of:
identifying an identification of an educational institution; and
identifying an identification of an employer.

15. A computer system comprising:
a processor;
a memory device holding an instruction set executable on the processor to cause the computer system to perform operations comprising:
identifying a particular type of profile attribute of a member account in a social network;
determining a target member account qualifies for an update with the particular type of profile attribute;
generating a prompt based on the particular type of profile attribute;
generating profile update content based on the target member account's response to the prompt; and
including the particular type of profile attribute in the target member account according to the profile update content.

16. The computer system of claim 15, wherein determining a target member account qualifies for an update with the particular type of profile attribute comprises:
generating an inquiry based on the particular type of profile attribute for the member account; and
responsive to the inquiry, receiving an identification of the target member account.

17. The computer system of claim 16, wherein identifying a particular type of profile attribute of a member account in a social network comprises:
determining a profile of the member account in the social network meets a profile completeness threshold; and
identifying the particular type of profile attribute from the profile of the member account.

18. The computer system of claim 17, wherein receiving an identification of the target member account comprises:
validating the target member based at least on (a) at least a degree of connection in the social network exists between member account and the target member account and (b) a profile of the target member account in the social network fails to meet the profile completeness threshold.

19. The computer system of claim 16, wherein identifying a particular type of profile attribute of a member account in a social network comprises:
determining the member account in the social network meets an engagement usage threshold; and
identifying the particular type of profile attribute from the profile of the member account.

20. The computer system of claim 19, wherein receiving an identification of the target member account comprises:
validating the target member based at least on (a) at least a degree of connection in the social network exists between member account and the target member account and (b) the target member account in the social network fails to meet the engagement usage threshold.
